(19) United States
(12) Patent Application Publication
(10) Pub. No.: US 2011/0057965 A1
(43) Pub. Date: Mar. 10, 2011

(54) LIQUID CRYSTAL DISPLAY DEVICE INCLUDING EDGE-TYPE BACKLIGHT UNIT AND METHOD OF CONTROLLING THE LIQUID CRYSTAL DISPLAY

(75) Inventors: Sang-moo PARK, Yongin-si (KR); Jung-hoon YOON, Suwon-si (KR); Dae-sik KIM, Hwaseong-si (KR); Ho-seop LEE, Seongnam-si (KR); Jong-hoon JUNG, Suwon-si (KR)

(73) Assignee: SAMSUNG ELECTRONICS CO., LTD., Suwon-si (KR)

(21) Appl. No.: 12/875,502

(22) Filed: Sep. 3, 2010

Related U.S. Application Data
(60) Provisional application No. 61/239,835, filed on Sep. 4, 2009.

(30) Foreign Application Priority Data
Oct. 30, 2009 (KR) 10-2009-0104424

(51) Int. Cl. G09G 3/36; G09G 5/10

(52) U.S. Cl. 345/690; 345/102

(57) ABSTRACT

A method of controlling a liquid crystal display (LCD) device including an LCD panel and an edge-type backlight unit is provided. The method includes: controlling turn-on and turn-off periods of an upper light source unit and a lower light source unit of the edge-type backlight unit to be synchronized with a period during which a 3D image is output on the LCD panel, wherein the upper light source unit includes a light source disposed at an upper edge of the edge-type backlight unit, and the lower light source unit includes a light source disposed at a lower edge of the edge-type backlight unit.

### CROSS-REFERENCE TO RELATED PATENT APPLICATIONS

This application claims priority from U.S. Provisional Application No. 61/239,835, filed Sep. 4, 2009, and Korean Patent Application No. 10-2009-0104424, filed Oct. 30, 2009, in the Korean Intellectual Property Office, the disclosures of which are incorporated herein in their entirety by reference.

### BACKGROUND

1. Field

Apparatuses and methods consistent with exemplary embodiments relate to a liquid crystal display (LCD) devices.

2. Description of the Related Art

Three-dimensional (3D) image display devices which display stereoscopic images have been recently developed. A stereoscopic image is generated by the stereoscopic viewing principle of human's eyes, and binocular parallax, which is the apparent difference in position of an object as seen separately by the human eyes separated by a distance of approximately 65 mm. By showing images which are the same as actually seen by the eyes, stereoscopic depth can be produced. Images are captured by using two cameras of the same type that are separated from each other by the distance of the human eyes. An image captured using the left-side camera is shown to a left eye, and an image captured using the right-side camera is shown to a right eye.

The 3D image display devices are classified as glasses type and glasses-free type. Examples of a stereoscopic display method of the glasses type includes a polarizing glasses method and a shutter glasses method. Examples of glasses-free stereoscopic display method include a parallax barrier method, a lenticular method, an integral imaging method, a holography method, etc.

In the shutter glasses method, glasses including a liquid crystal shutter, that is, liquid crystal shutter glasses, are used to create a stereoscopic image. In the liquid crystal shutter glass method, different images are respectively shown to a left eye and a right eye during a frequency period of 60 Hz. A 3D display device using the liquid crystal shutter glasses method alternately and rapidly displays a left image and right image, and opens or closes liquid crystal shutters for the left eye image and the right eye image alternately.

However, when the data holding is generated in an LCD device, the cross-talk or X-talk between a left image and a right image which exist mixedly within one frame output by the LCD device is generated due to the data holding phenomenon.

In detail, when a left image or a right image is output on an upper portion of the screen, an area for a right image or a left image is reversely output on a lower portion of the screen, and accordingly, there is a time when the left image and the right image are output on the screen at the same time. When the backlight unit is turned on, a left image and a right image of one frame, which are adjacent to each other, are mixedly seen to one eye of the viewer, and a cross-talk is generated. Thus, the left eye and the right eye of the viewer see a distorted image due to the cross-talk, and the viewer may become fatigued watching a 3D image.

### SUMMARY

Exemplary embodiments address at least the above problems and/or disadvantages and other disadvantages not described above. Also, an exemplary embodiment is not required to overcome the disadvantages described above, and an exemplary embodiment may not overcome any of the problems described above.

Exemplary embodiments provide an LCD device and a method of controlling the LCD device.

According to an aspect of an exemplary embodiment, there is provided a method of controlling an LCD device including an LCD panel and an edge-type backlight unit, the method including: controlling turn-on and turn-off periods of an upper light source and a lower light source of the edge-type backlight unit so as to be synchronized with a period during which a 3D image is output on the LCD panel, wherein the upper light source includes a light source disposed at an upper edge of the edge-type backlight unit, and the lower light source includes a light source disposed at a lower edge of the edge-type backlight unit.

The controlling of the turned-on and turned-off periods of an upper light source and an lower light source of the edge-type backlight unit may include turning-on the upper light source and turning-off the lower light source when a current image is output on an upper portion of a screen and a previous image remains on a lower portion of the screen.

The controlling of the turn-on and turn-off periods of an upper light source and a lower light source of the edge-type backlight unit may include turning-off the upper light source and turning-on the lower light source when a next image starts to be output on an upper portion of a screen and a current image is output on a lower portion of the screen.

The controlling of the turn-on and turn-off periods of an upper light source and a lower light source of the edge-type backlight unit may include turning-off both the upper light source and the lower light source when a ratio of a current image to a previous image that mixedly exists on the whole screen is a predetermined threshold or greater.

The controlling of the turn-on and turn-off periods of an upper light source and a lower light source of the edge-type backlight unit may include turning-on both the upper light source and the lower light source when a ratio that a current image and a previous image mixedly exist over the whole screen is smaller than a predetermined threshold.

When the edge-type backlight unit further includes light sources disposed on left and right edges of the edge-type backlight unit, the light sources may be classified into upper light sources and lower light sources, and the upper light sources of the edge-type backlight unit may include a light source at an upper edge and light sources at upper left and right edges of the edge-type backlight unit, and the lower light sources of the edge-type backlight unit may include a light source at a lower edge and light sources at lower left and right edges of the edge-type backlight unit of the edge-type backlight unit.

In the controlling of the turn-on and turn-off periods of an upper light source and a lower light source of the edge-type backlight unit, the turn-on and turn-off periods may be synchronized with a period in which a 3D image is output on the LCD panel by using a vertical synchronization (V-sync) signal.

The method may further include controlling the LCD panel such that a left image and a right image of the 3D image are alternately output on the LCD panel.

In the controlling of the LCD panel, during a period in which a pair of a left image and a right image corresponding to each other are alternately output, the left image, a black image, the right image, and the black image may be sequentially output.

In the controlling of the LCD panel, during a period in which a pair of a left image and a right image corresponding to each other are alternately output, the left image, the left image, the right image, and the right image may be sequentially output.

In the controlling of the LCD panel, the images may be sequentially output from an upper portion to a lower portion of the LCD panel.

In the controlling of the LCD panel, the 3D image may be controlled to be output on the LCD panel at a frequency of 240 Hz.

In the controlling of the turn-on and turn-off periods of an upper light source and a lower light source of the edge-type backlight unit, a period T, during which one of a left image and a right image of the 3D image is output and a next image is output on the LCD panel, may be divided into six sections, and the upper light source may be turned on in a second section and a third section, and turned off in a first section, a fourth section, a fifth section, and a sixth section, and the lower light source may be turned on in the fourth section and the fifth section, and turned off in the first section, the second section, the third section, and the sixth section, wherein the controlling during the period T is repeated.

In the controlling of the turn-on and turn-off periods of an upper light source and a lower light source of the edge-type backlight unit, a period T, during which one of a left image and a right image of the 3D image is output and a next image is output on the LCD panel, may be divided into eight sections, and the upper light source may be turned on in a second section, a third section, a fourth section, and an fifth section, and turned off in a first section, a sixth section, a seventh section, and a eighth section, and the lower light source may be turned on in the fourth section, the fifth section, the sixth section, and the seventh section, and turned off in the first section, the second section, the third section, and the eighth section, wherein the controlling during the period T is repeated.

When the LCD panel further includes a shutter glass for a left image of the 3D image and a shutter glass for a right image of the 3D image, the method may further include, during a period T in which one of the left image and the right image of the 3D image is output and a next image is output on the LCD panel, controlling the shutter glasses such that the shutter glass for the left image is opened while the left image is being output if the left image is first output, and the shutter glass for the right image is opened while the right image is being output if the right image is first output.

According to an aspect of another exemplary embodiment, there is provided an LCD device including: an LCD panel; an edge-type backlight unit in which light sources are disposed at upper and lower edges of the edge-type backlight unit; an LCD panel control unit controlling the LCD panel such that a left image and a right image of a 3D image are alternately output on the LCD panel; and a backlight control unit classifying the light sources of the edge-type backlight unit into upper light sources including light sources disposed at the upper edge of the edge-type backlight unit and lower light sources including light sources disposed at the lower edge of the edge-type backlight unit and controlling turn-on and turn-off periods of the upper light sources and the lower light sources of the edge-type backlight unit to be synchronized with a period during which a 3D image is output on the LCD panel.

The LCD device may further include: shutter glasses respectively for the left image and the right image; and a shutter glass control unit controlling opening and closing of the shutter glasses so as to be synchronized with a period during which the 3D image is output on the LCD panel.

According to an aspect of another exemplary embodiment, there is provided a computer-readable recording medium having embodied thereon a program for executing the method of controlling the LCD device described above.

### BRIEF DESCRIPTION OF THE DRAWINGS

The above and other aspects will become more apparent by describing certain exemplary embodiments with reference to the accompanying drawings, in which:

FIG. 1 illustrates a block diagram of an LCD device including an edge-type backlight unit, according to an exemplary embodiment;

FIGS. 2A and 2B illustrate synchronization between an output period of a 3D image to an LCD panel, a turn-on/off period of light sources of a backlight unit, and an opening/closing period of shutter glasses;

FIGS. 3A and 3B illustrate an edge-type backlight unit in which light sources are disposed at an upper edge or a lower edge of the edge-type backlight unit, according to an exemplary embodiment;

FIGS. 4A and 4B illustrate an edge-type backlight unit in which light sources are disposed at upper and lower edges and at left and right edges of the edge-type backlight unit, according to an exemplary embodiment;

FIG. 5 illustrates a method of synchronizing a 3D image output period of an LCD panel, a turn-on/off period of light sources of a backlight unit, and an opening/closing period of shutter glasses, according to an exemplary embodiment;

FIG. 6 illustrates a method of synchronizing a 3D image output period of an LCD panel, a turn-on/off period of light sources of a backlight unit, and an opening/closing period of shutter glasses, according to another exemplary embodiment;

FIG. 7 illustrates a method of synchronizing a 3D image output period of an LCD panel, a turn-on/off period of light sources of a backlight unit, and an opening/closing period of shutter glasses, according to another exemplary embodiment;

FIG. 8 illustrates a method of synchronizing a 3D image output period of an LCD panel, a turn-on/off period of light sources of a backlight unit, and an opening/closing period of shutter glasses, according to another exemplary embodiment; and

FIG. 9 illustrates a flowchart illustrating a method of controlling an LCD device including an edge-type backlight unit, according to an exemplary embodiment.

### DETAILED DESCRIPTION OF EXEMPLARY EMBODIMENTS

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters.

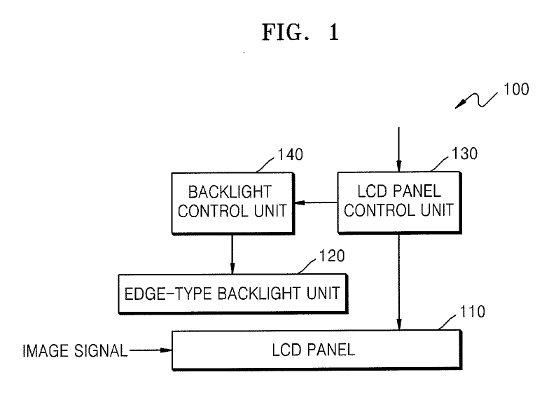

FIG. 1 illustrates a block diagram of an LCD device 100 including an edge-type backlight unit 120, according to an exemplary embodiment.

The LCD device 100 includes an LCD panel 110, an edge-type backlight unit 120, an LCD panel control unit 130, and a backlight control unit 140 for controlling light sources of the edge-type backlight unit 120.

The LCD panel 110 receives an image signal and outputs the image signal on a screen. The LCD device 100 outputs a 3D image signal to the LCD panel 110 to display a 3D image. The 3D image signal includes a left image signal and a right image signal by which a left image and a right image are alternately output on the LCD panel 110, thereby generating a 3D image.

In a 3D display method using a liquid crystal shutter glass method, a left image and a right image are displayed to a left eye and a right eye at a predetermined frequency, respectively. In the LCD device 100 using the liquid crystal shutter glass method, a left image and a right image are alternately and rapidly output on the LCD panel 110. A shutter glass for a left image and a shutter glass for a right eye are alternately open or closed.

The edge-type backlight unit 120 includes an upper light source unit and a lower light source unit. For example, the upper light unit includes at least one light source disposed at an upper edge and the lower light source unit includes at least one light source disposed a lower edge of the edge-type backlight unit 120. As light is irradiated by a light source of the edge-type backlight unit 120 to the LCD panel 110, an image output on the LCD panel 110 may be visualized.

Additionally, the edge-type backlight unit 120 may include light sources disposed on left and right edges of the edge-type backlight unit 120. In this case, the upper light source unit of the edge-type backlight unit 120 may include at least one upper left light source disposed at an upper portion of the left edge and/or at least one upper right light source disposed at an upper portion of the right edge, in addition to or instead of the light source disposed at the upper edge. The lower light source unit of the edge-type backlight unit 120 may include at least one lower left light source disposed at a lower portion of the left edge and/or at least one lower right light source disposed at a lower portion of the right edge, in addition to or instead of the lower light source disposed at the lower edge.

The LCD panel control unit 130 controls the output periods of image signals output to the LCD panel 110. The LCD panel control unit 130 may control left and right images among 3D images to be alternately output on the LCD panel 110 in order to generate a 3D image. As driving voltages corresponding to a left image signal and a right image signal among 3D image signals input to the LCD panel 110 are alternately applied to the LCD panel 110, a left image and a right image may be alternately output on the LCD panel 110.

Also, the LCD panel control unit 130 may control the output periods of a left image and a right image output to the LCD panel 110 to generate a 3D image. For example, the LCD panel control unit 130 may control the output periods of the images such that a left image, a black image, a right image, and a black image are sequentially output during one period in which a pair of a left image and a right image corresponding to each other are alternately output. Also, the LCD panel control unit 130 may control the output periods of the images such that a left image, a left image, a right image, and a right image are sequentially output during one period in which a pair of a left image and a right image corresponding to each other are alternately output.

The LCD panel control unit 130 may control a left image and a right image of one frame to be converted to four frames including a left image, a black image, a right image, and a black image or to four frames including a left image, a left image, a right image, and a right image and may control to output one set including four frames at a frequency period of 240 Hz.

As a left image and a right image are rapidly and alternately output, a 3D image is displayed. However, due to the data holding characteristics of the LCD panel 110, if a new frame is output before an afterimage of a previous frame disappears, a cross-talk may be generated. Accordingly, by inserting a black image between a left image and a right image, or increasing a frequency period by repeating one identical frame, the cross-talk may be further reduced.

The LCD panel control unit 130 controls the images to be sequentially output from an upper portion to a lower portion of the LCD panel 110. Accordingly, a previous frame is output on a lower portion of a screen of the LCD panel 110, and a section of a new frame is output on an upper portion of the screen of the LCD panel 110.

The backlight control unit 140 for the light sources of the edge-type backlight unit 120 controls turning the light sources on and off in synchronization with an output period of a 3D image output to the LCD panel 110. The backlight control unit 140 may obtain information about an output period of a 3D image of the LCD panel 110 from the LCD panel control unit 130. Also, the backlight control unit 140 may obtain information about an output period of a 3D image by using a V-sync signal.

The backlight control unit 140 controls turning on and off of the upper light source unit and the lower light source unit of the edge-type backlight unit 120. For example, if a current main frame is output on an upper portion of the screen of the LCD panel 110, the backlight control unit 140 may turn on the upper light source unit of the edge-type backlight unit 120, and if a current main frame is output on a lower portion of the screen of the LCD panel 110, the backlight control unit 140 may turn on the lower light source unit of the edge-type backlight unit 120.

Also, the backlight control unit 140 may turn on the upper light source unit and turn off the lower light source unit while a current image is output on the upper portion of the screen and a previous image is left on the lower portion of the screen. In a similar manner, the backlight control unit 140 may turn off the upper light source unit and turn on the lower light source unit when a next image starts to be output on the upper portion of the screen and a current image is output on the lower portion of the screen.

The backlight control unit 140 may turn on or off the upper light source unit and the lower light source unit of the edge-type backlight unit 120 based on a ratio of a left image and a right image that mixedly exist on the screen, which may cause the cross-talk. For example, if the ratio of a current image and a previous image that mixedly exist over the entire screen of the LCD panel 110 is a predetermined threshold or greater, the upper light source unit and the lower light source unit may be turned off. Further, the backlight control unit 140 may turn on the upper light source unit and the lower light source unit when a ratio of a left image and a right image that mixedly exist on the screen is smaller than a predetermined threshold.

The LCD device 100 may control an opening/closing period of a shutter glass in synchronization with an output period of a 3D image. For example, one of a left image and a right image is output on the LCD panel 110 and a next image (e.g., a remaining image of one of a left image and a right image, or a black image) is output during a period T. The LCD device 100 may control such that if a left image is output first, a shutter glass for the left image is open while the left image is being output, and if a right image is output first, a shutter glass for the right eye may be open while the right image is being output.

Accordingly, the LCD device 110 controls turning on or off the light sources in the upper and lower portions of the edge-type backlight unit 120 individually according to a V-sync signal, thereby preventing the cross-talk that is generated due to the data holding characteristics of the LCD device 100.

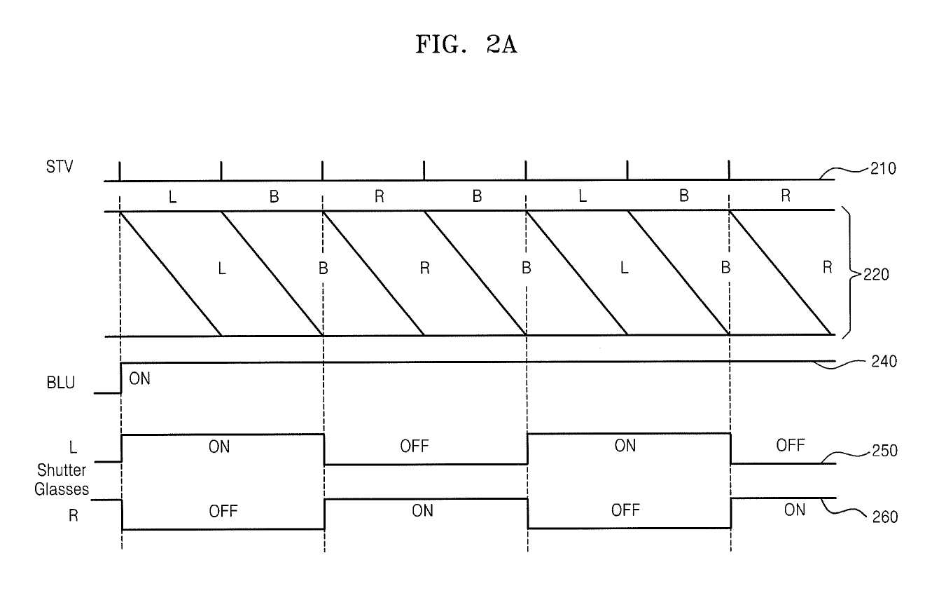

FIGS. 2A and 2B illustrate synchronizations between a 3D image output period of an LCD panel, a turn-on/off period of a light source of a backlight unit, and an opening/closing period of a shutter glass.

In FIGS. 2A and 2B, a horizontal axis of timing diagrams 210, 220, 230, 240, 250, and 260 is a time axis. The timing diagram 220 or 230 of an output period of a 3D image, the timing diagram 240 of a turn-on/off period of the backlight unit, and the timing diagrams 250 and 260 of an opening/closing period of shutter glasses are illustrated in synchronization with the timing diagram 210 of a V-sync start signal STV.

A vertical axis of the timing diagram 220 or 230 of the output period of a 3D image denotes a vertical axis viewed on the screen of the LCD panel. Accordingly, referring to the timing diagram 220 or 230 of the output period of the 3D image, one sheet of frames is sequentially displayed from an upper portion to a lower portion of the screen according to time when a V-sync start signal STV is input twice.

The timing diagram 220 of an output period of a 3D image illustrates a timing diagram when a 3D image of one frame is converted to four frames including a left image, a black image, a right image, and a black image. The timing diagram 230 of an output period of a 3D image illustrates a timing diagram when a 3D image of one frame is converted to four frames including a left image, a left image, a right image, and a right image so that the 3D image of one frame is output at a frequency of 240 Hz. The images including four frames are synchronized with a V-sync signal at a frequency of 240 Hz and are alternately output.

According to the timing diagram 240 of a turn-on/off period of the backlight unit, the light sources are turned on from a time point when a frame is output on the LCD panel according to a V-sync signal and irradiate light to the LCD panel while frames are consecutively being output thereon.

Referring to the timing diagrams 250 and 260 of the opening/closing periods of the shutter glasses, a left eye shutter glass and a right eye shutter glass are repeatedly and alternately open or closed during a left image output period and a right image output period, respectively. As a result, a user may view a 3D image.

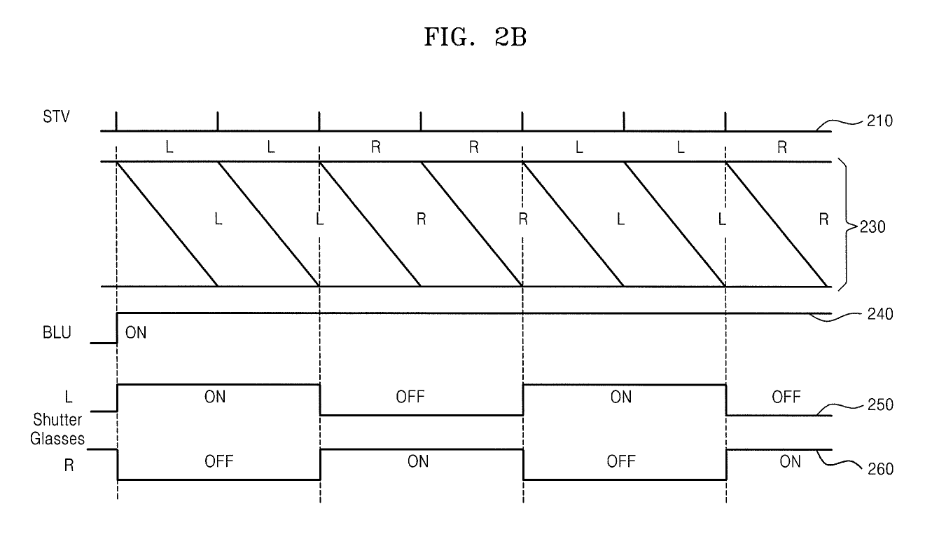

FIGS. 3A and 3B illustrate an edge-type backlight unit 300 in which light sources are disposed on upper and lower edges, according to an exemplary embodiment.

The upper light source unit includes upper light sources 310 and the lower light source unit includes lower light sources 320. The upper and lower light sources 310 and 320 are disposed on upper and lower edges of the edge-type backlight unit 300, respectively. The backlight control unit 140 of the LCD device 100 controls the upper light sources 310 of the upper light source unit and the lower light sources 320 of the lower light source unit of the edge-type backlight unit 300 separately. In detail, the backlight control unit 140 may control turning on and off the upper light sources 310 and the lower light sources 320 in synchronization with a V-sync signal.

In FIG. 3A, the upper light sources 310 are turned on, and the lower light sources 320 are turned off, and thus an upper portion 352 of a screen of an LCD device 350 is bright, and a lower portion 354 of the screen of the LCD device 350 is dark. In FIG. 3B, the upper light sources 310 are turned off, and the lower light sources 320 are turned on, and thus the upper portion of the screen of the LCD device 350 is dark, and the lower portion 354 of the screen of the LCD device 350 is bright.

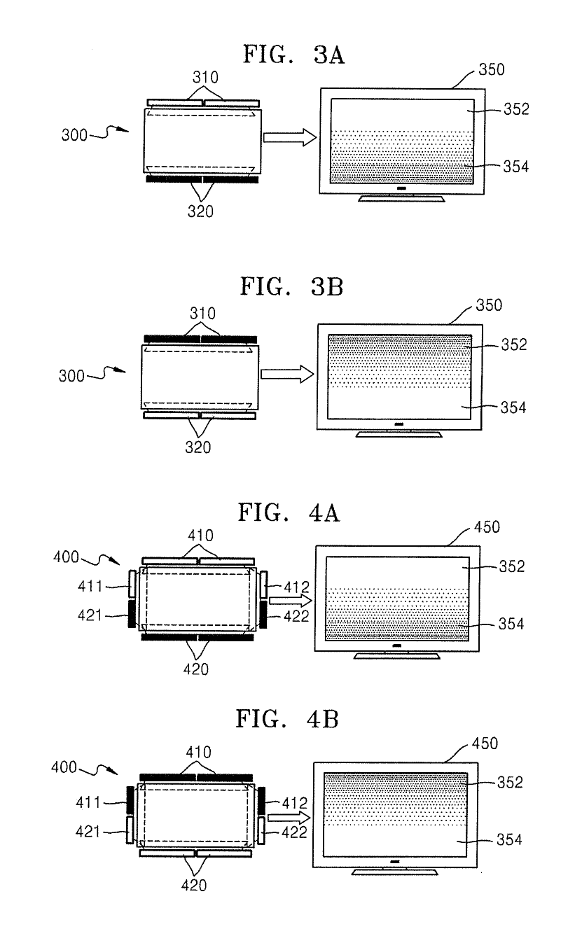

FIGS. 4A and 4B illustrate an edge-type backlight unit 400 in which light sources are disposed on upper and lower edges and left and right edges, according to an exemplary embodiment.

In the edge-type backlight unit 400, an upper light source unit includes upper light sources 410 disposed on an upper edge of the backlight unit 400, and upper light sources 411 and 412 disposed on left and right edges of the backlight unit 400. The lower light source unit includes lower light sources 420 disposed on a lower edge of the backlight unit 400 and lower light sources 421 and 422 disposed on left and right edges of the backlight unit 400. The backlight control unit 140 of the LCD device 100 may separately control the upper light sources 410, 411, and 412 disposed on the upper edge and upper portions of the left and right edges, and the lower light sources 420, 421, and 422 disposed on the lower edge and lower portions of the left and right edges. The backlight control unit 140 may control turning on and off the upper light sources and lower light sources in synchronization with a V-sync signal.

In FIG. 4A, the upper light sources 410, 411, 421 are turned on, and the lower light sources 420, 421, 422 are turned off, and thus an upper portion of a screen of an LCD device 450 is bright, and a lower portion of the screen of the LCD device 450 is dark. In FIG. 4B, the upper light sources 410, 411, 421 are turned off, and the lower light sources 420, 421, 422 are turned on, and thus the upper portion of the screen of the LCD device 450 is dark and the lower portion 354 of the screen of the LCD device 450 is bright.

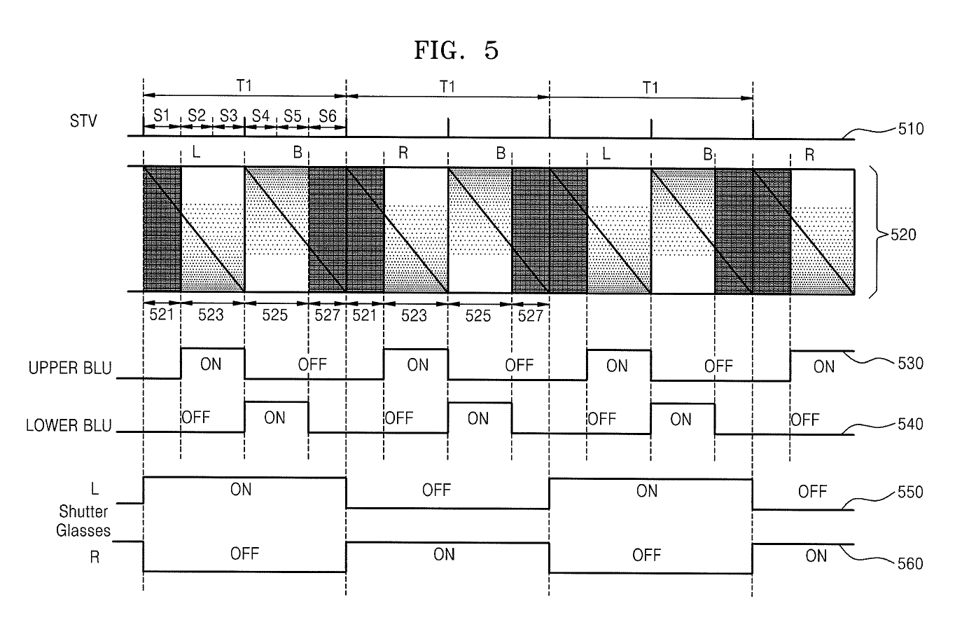

FIG. 5 illustrates a method of synchronizing a 3D image output period of an LCD panel, a turn-on/off period of light sources of a backlight unit, and an opening/closing period of shutter glasses, according to an exemplary embodiment.

A timing diagram 520 of an output period of a 3D image, timing diagrams 530 and 540 of a turn-on/off period of the light sources of the edge-type backlight unit 120, and timing diagrams 550 and 560 of an opening/closing period of the shutter glasses of the LCD panel 110 are synchronized with a timing diagram 510 of a V-sync start signal STV.

According to the timing diagram 520 of an output period of a 3D image, four frames including a left image, a black image, a right image, and a black image that are converted to correspond to one frame of a 3D image are alternately output on the LCD panel 110 at a frequency of 240 Hz. As discussed above, the LCD screen displays according to the data holding characteristics of the LCD device 100 the left image, the right image, and the black image which are synchronized with a V-sync start signal STV and output on the LCD panel 110. A method of controlling turning on and off the light sources by the backlight control unit 140 is described in detail below.

In a section 521, a cross-talk is generated over the entire screen due to a previous image that is left due to data holding characteristics of the LCD device 100, and thus the backlight control unit 140 turns off the upper light source unit and the lower light source unit of the edge-type backlight unit 120.

In a section 523, the previous image is left due to the data holding characteristics of the LCD device 100 on a lower portion of a screen. The backlight control unit 140 turns on the upper light source unit of the edge-type backlight unit 120.

In a section 525, a next image is output on the upper portion of the screen. The backlight control unit 140 turns off the upper light source unit and turns on the lower light source unit.

In a section 527, since a next image is displayed over the entire screen, the backlight control unit 140 turns off the upper light source unit and the lower light source unit.

According to the timing diagrams 550 and 560 of the opening/closing period of the shutter glasses, while a left image is being output, the shutter glass for a left image is open and the shutter glass for a right eye is closed in synchronization with a V-sync start signal. Also, while the right image is being output, the shutter glass for the right eye is controlled to be open, and the shutter glass for a left image is controlled to be closed in synchronization with a V-sync start signal.

Although one set including four frames that are converted to correspond to one frame is described above, if all the frames are controlled in the above-described manner, the cross-talk due to left and right images that are adjacent to each other may be prevented or eliminated.

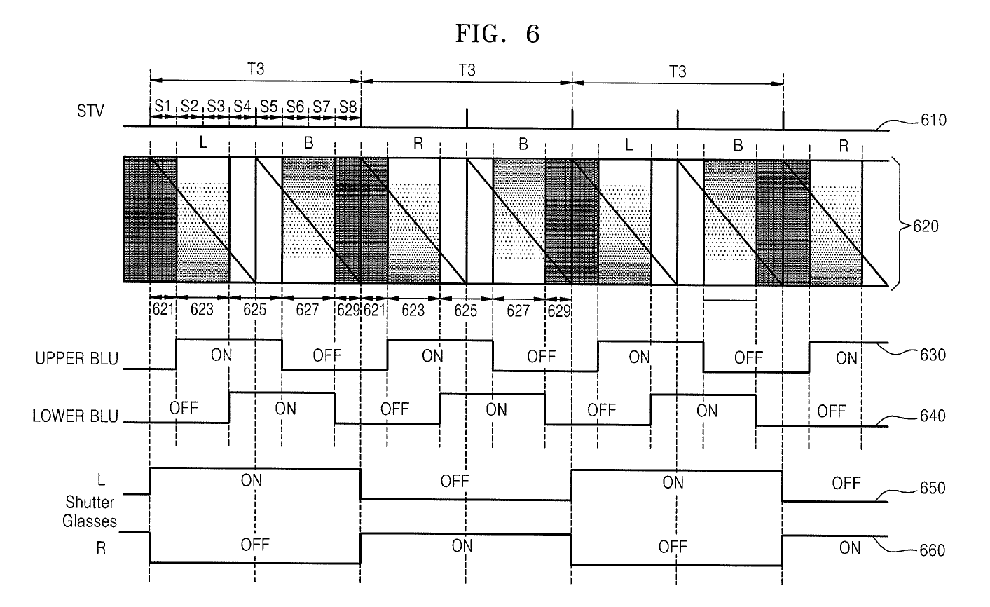

FIG. 6 illustrates a method of synchronizing a 3D image output period of an LCD panel, a turn-on/off period of light sources of a backlight unit, and an opening/closing period of shutter glasses, according to another exemplary embodiment.

A timing diagram 620 of an output period of a 3D image, timing diagrams 630 and 640 of a turn-on/off period of the light sources of the edge-type backlight unit 120, and timing diagrams 650 and 660 of an opening/closing period of the shutter glasses of the LCD panel 110 are synchronized with a timing diagram 610 of a V-sync start signal STV.

In a section 621, a cross-talk is generated over the entire screen due to a previous image that is left due to the data holding characteristics of the LCD device 100, and thus the backlight control unit 140 turns off the upper light source unit and the lower light source unit of the edge-type backlight unit 120.

In a section 622, the previous image is left due to the data holding characteristics of the LCD device 100 on a lower portion of a screen. The backlight control unit 140 turns on only the upper light source unit of the edge-type backlight unit 120.

In a section 625, a ratio of a left image and a right image that mixedly exist on the screen is smaller than a predetermined threshold. The backlight control unit 140 turns on the upper light source unit and the lower light source unit. The method of controlling the light sources of the edge-type backlight light unit 120 is similar to that of FIG. 5 except that a control section such as the section 625 is inserted.

In a section 627, a next image is output on an upper portion of a screen. The backlight control unit 140 turns off the upper light source unit of the edge-type backlight unit 120 and maintains the lower light source unit of the edge-type backlight unit 120 turned on.

In a section 629, a next image is displayed over the entire screen. The backlight control unit 140 turns off the upper light source unit and the lower light source unit.

According to the timing diagrams 650 and 660 of the opening/closing period of the shutter glasses, the shutter glass for a left image and the shutter glass for a right image are open or closed in synchronization with a V-sync start signal STV as shown by the timing diagrams 650 and 660.

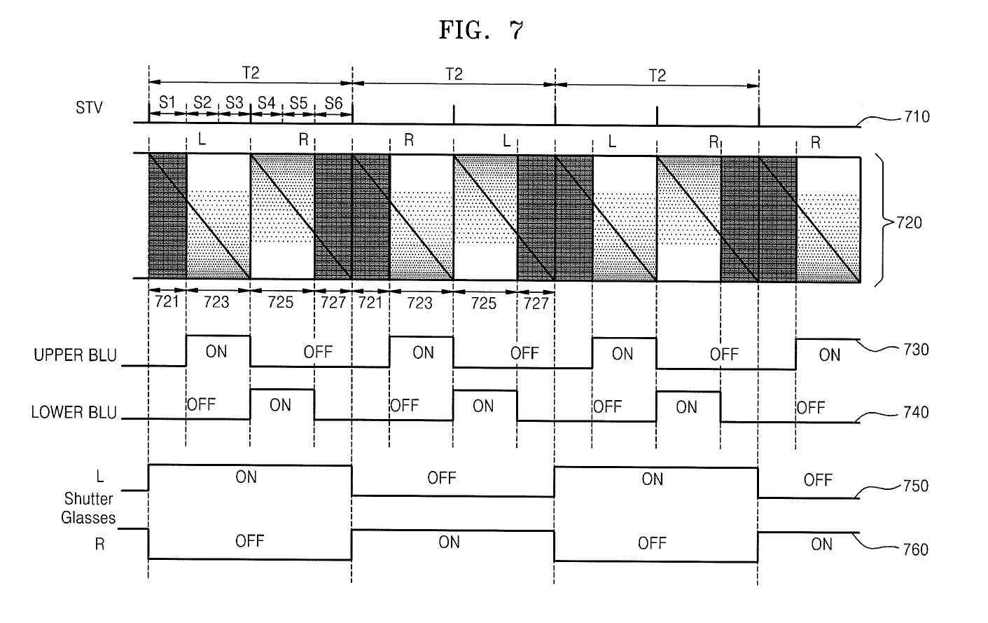

FIG. 7 illustrates a method of synchronizing a 3D image output period of an LCD panel, a turn-on/off period of light sources of a backlight unit, and an opening/closing period of shutter glasses, according to another exemplary embodiment.

A timing diagram 720 of an output period of a 3D image, timing diagrams 730 and 740 of a turn-on/off period of the light sources of the edge-type backlight unit 120, and timing diagrams 750 and 760 of an opening/closing period of the shutter glasses of the LCD panel 110 are synchronized with a timing diagram 710 of a V-sync start signal STV.

Referring to the timing diagram 720 of an output period of a 3D image, a left image, a right image, a right image, and a left image, a left image, a right image and a right image are output. That is, four frames including a left image, a left image, a right image, and a right image that are converted to correspond to one frame of a 3D image are alternately output on the LCD panel 110 at a frequency of 240 Hz. As discussed above, the LCD screen displays according to the data holding characteristics of the LCD display 110 the left image and the right image which are synchronized with a V-sync start signal STV and output on the LCD panel 110. A method of controlling turning on and off the light sources of the edge-type backlight unit 120 by the backlight control unit 140 is described in detail below.

In a section 721, a cross-talk is generated over the entire screen due to a previous image that is left due to the data holding characteristics of the LCD device 100, and thus the backlight control unit 140 turns off the upper light source unit and the lower light source unit of the edge-type backlight unit 120.

In a section 723, the previous image is left due to the data holding characteristics of the LCD device 100 on a lower portion of a screen. The backlight control unit 140 turns on only the upper light source unit of the edge-type backlight unit 120.

In a section 725, a next image is output on an upper portion of the screen. The upper light source unit of the edge-type backlight unit 120 is turned off, and the lower light source unit of the edge-type backlight unit 120 is turned on.

In a section 727, a next image is output on the entire screen. The upper light source unit and the lower light source unit of the edge-type backlight unit 120 are turned off.

According to the timing diagrams 750 and 760 of the opening/closing period of the shutter glasses, the shutter glass for a left image is open and the shutter glass for a right image is closed if a first frame, which is output first in synchronization with a V-sync start signal, contains the left image. Also, if a first frame, which is output first, contains the right image, the shutter glass for a right image is controlled to be open and the shutter glass for a left image is controlled to be closed in synchronization with a V-sync start signal.

One set including four frames that are converted to correspond to one frame is described above, but if all the frames are controlled in the above-described manner, the cross-talk due to left and right images that are adjacent to each other may be prevented or eliminated.

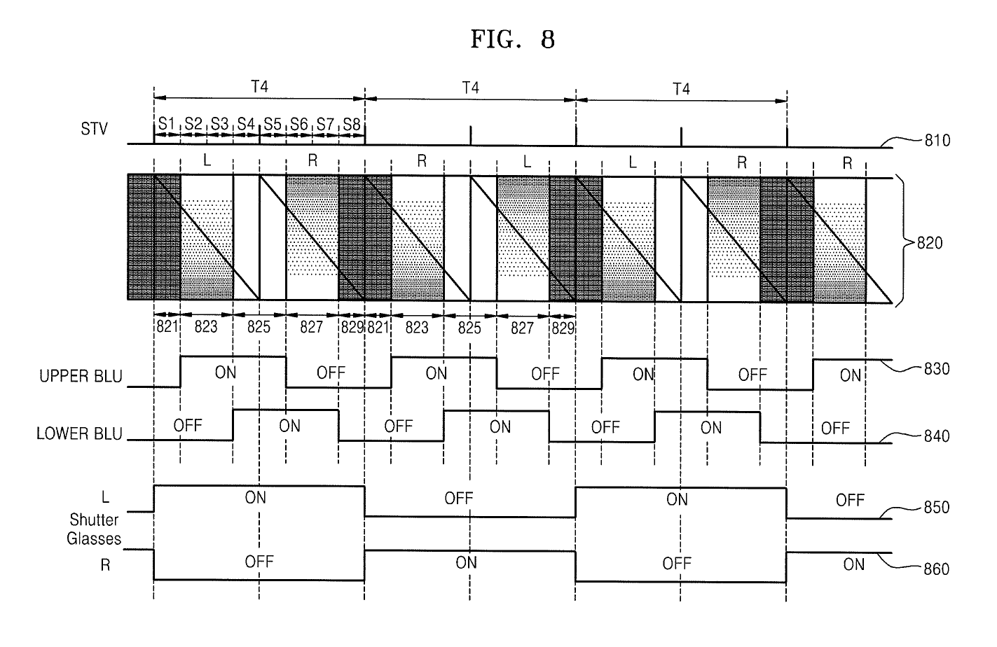

FIG. 8 illustrates a method of synchronizing a 3D image output period of an LCD panel, a turn-on/off period of light sources of a backlight unit, and an opening/closing period of shutter glasses, according to another exemplary embodiment.

A timing diagram 820 of an output period of a 3D image, timing diagrams 830 and 840 of a turn-on/off period of the light sources of the edge-type backlight unit 120, and timing diagrams 850 and 860 of opening/closing periods of the shutter glasses of the LCD panel 110 are synchronized with a timing diagram 810 of a V-sync start signal STV.

As discussed above, the LCD screen displays according to the data holding characteristics of the LCD device 100 four frames of the left image, the left image, the right image, and the right image, which are converted to correspond to one frame of a 3D image according to the timing diagram 820 of a 3D image output period, synchronized with a V-sync start signal STV at a frequency of 240 Hz, and output on the LCD panel 110. A method of turning on and off the light sources of the edge-type backlight unit 120 by the backlight control unit 140 is described in detail below.

In a section 821, a cross-talk is generated over the entire screen due to a previous image that is left due to the data holding characteristics of the LCD device 100, and thus the backlight control unit 140 turns off the upper light source unit and the lower light source unit of the edge-type backlight unit 120.

In a section 823, the previous image is left due to the data holding characteristics of the LCD device 100 on a lower portion of a screen. The backlight control unit 140 turns on only the upper light source unit of the edge-type backlight unit 120.

In a section 825, a ratio of a left image and a right image that mixedly exist on the screen is smaller than a predetermined threshold. The backlight control unit 140 turns on the upper light source unit and the lower light source unit. The method of controlling the light sources of the edge-type backlight light 120 is similar to that of FIG. 7 except that a control section such as the section 825 is inserted.

In a section 827, a next image is output on an upper portion of a screen. The backlight control unit 140 turns off the upper light source unit of the edge-type backlight unit 120 and maintains the lower light source unit of the edge-type backlight unit 120 turned on.

In a section 829, a next image is displayed over the entire screen. The backlight control unit 140 turns off the upper light source unit and the lower light source unit.

According to the timing diagrams 850 and 860 of the opening/closing periods of the shutter glasses, the shutter glass for a left image and the shutter glass for a right image are open or closed in synchronization with a V-sync start signal as shown by the timing diagrams 850 and 860.

To summarize, FIGS. 5 and 6 illustrate the diagrams when a 3D image of one frame is converted to one set including a left image, a black image, a right image, and a black image, and FIGS. 7 and 8 illustrate the diagrams when a 3D image of one frame is converted to one set including a left image, a left image, a right image, and a right image.

Also, in FIGS. 5 and 7, turn-on/off periods of the light sources of the edge-type backlight unit light 120 may be divided into six sections, and in FIGS. 6 and 8, turn-on/off periods of the light sources of the edge-type backlight unit light 120 may be divided into eight sections.

That is, in FIGS. 5 and 7, a period T1 during which one of a left image and a right image of a 3D image is output on the LCD panel 110 and a black image is output on the LCD panel 110 is divided into six sections. The upper light source unit is controlled to be turned on in a second section S2 and a third section S3, and turned off in a first section S1, a fourth section S4, a fifth section S5, and a sixth section S6. The lower light source unit is controlled to be turned on in the fourth section S4 and the fifth section S5 and turned off in the first section S1, the second section S2, the third section S3, and the sixth section S6.

The controlling during each period T1 is repeated periodically for each frame group including one of the left image and the right image and the black image, shown in FIGS. 5 and 7.

In FIGS. 6 and 8, a period T3 during which one of a left image and a right image of a 3D image is output on the LCD panel 110 and a next image of another type is output on the LCD panel 110 is divided into eight sections. The upper light source unit may be controlled to be turned on in a second section S2, a third section S3, a fourth section S4, and a fifth section S5, and turned off in a first section S1, a sixth section S6, a seventh section S7, and an eighth section S8. The lower light source unit may be controlled to be turned on in the fourth section S4, the fifth section S5, the sixth section S6, and the seventh section S7, and turned off in the first section S1, the second section S2, the third section S3, and the eighth section S8.

The controlling during each period T3 is repeated for each frame group including a left image or a right image, a black image and a control section, shown in FIGS. 6 and 8.

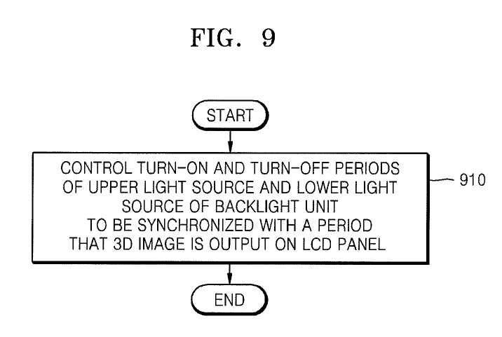

FIG. 9 illustrates a flowchart illustrating a method of controlling an LCD device including an edge-type backlight unit, according to an exemplary embodiment.

In operation 910, turn-on and turn-off periods of the upper light source unit and the lower light source unit of an edge-type backlight unit are controlled to be synchronized with an output period of a 3D image displayed on an LCD panel.

Light sources of the edge-type backlight unit include the upper light source unit and the lower light source unit. The upper light source unit may include one or more light sources disposed at an upper edge of the edge-type backlight unit, and the lower light source unit may include one or more light sources disposed at a lower edge of the edge-type backlight unit. The light sources of the edge-type backlight unit may further include light sources that are disposed at left and right edges of the edge-type backlight unit. Accordingly, the upper light source unit of the edge-type backlight unit may include one or more upper light sources disposed at an upper edge and one or more light sources disposed at upper left and right edges of the edge-type backlight unit. The lower light source unit of the edge-type backlight unit may include one or more lower light sources disposed at a lower edge and one or more light sources disposed at lower left and right edges of the edge-type backlight unit.

As a current image is output on an upper portion of a screen and a previous image is still left at a lower portion of the screen, the controlling of the light sources of the edge-type backlight unit may include turning on the upper light source unit and turning off the lower light source unit, and turning off the upper light source unit and turning on the lower light source unit when a next image starts to be output on the upper portion of the screen and a current image is output on the lower portion of the screen.

Also, the controlling of the light sources of the edge-type backlight unit may include turning-off the upper light source unit and the lower light source unit if a ratio of a current image and a previous image that mixedly exist over the entire screen is a predetermined threshold or greater, and turning on the upper light source unit and the lower light source unit if the ratio of a current image and a previous image that mixedly exist over the entire screen is smaller than the predetermined threshold.

The controlling of the light sources of the edge-type backlight unit may be synchronized with a period in which a 3D image is output on the LCD panel by using a V-sync signal of an LCD device.

The method of controlling an LCD device may further include controlling the LCD panel such that a left image and a right image of the 3D image are alternately output. One frame of the 3D image may be converted to four frames in order of a left image, a black image, a right image, and a black image or to four frames in order of a left image, a left image, a right image, and a right image, and be output at a frequency of 240 Hz. The images may be sequentially output from an upper portion to a lower portion of the LCD panel.

According to exemplary embodiments, the light sources of the edge-type backlight unit are controlled so that an area where a left image and a right image are mixedly output on the LCD panel is not viewed by the viewer, thereby preventing the cross-talk.

Exemplary embodiments can be implemented as computer programs and can be implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), etc.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of controlling a liquid crystal display (LCD) device comprising an LCD panel and an edge-type backlight unit, the method comprising:
controlling turn-on and turn-off periods of an upper light source unit and a lower light source unit of the edge-type backlight unit to be synchronized with a period during which a three dimensional (3D) image is output on the LCD panel,
wherein the upper light source unit comprises a light source disposed at an upper edge of the edge-type backlight unit, and the lower light source unit comprises a light source disposed at a lower edge of the edge-type backlight unit.

2. The method of claim 1, wherein the controlling the turn-on and turn-off periods comprises turning-on the upper light source unit and turning-off the lower light source unit when a current image is output on an upper portion of a screen and a previous image remains on a lower portion of the screen.

3. The method of claim 1, wherein the controlling the turn-on and turn-off periods comprises turning-off the upper light source unit and turning-on the lower light source unit when a next image starts to be output on an upper portion of a screen and a current image is output on a lower portion of the screen.

4. The method of claim 1, wherein the controlling the turn-on and turn-off periods comprises turning-off the upper light source unit and the lower light source unit if a ratio of a current image to a previous image that mixedly exist on an entire screen is greater than or equal to a threshold.

5. The method of claim 1, wherein the controlling the turn-on and turn-off periods comprises turning-on the upper light source unit and the lower light source unit if a ratio of a current image and a previous image that mixedly exist over an entire screen is smaller than a threshold.

6. The method of claim 1, wherein
the upper light source unit of the edge-type backlight unit further comprises light sources disposed on an upper left edge and an upper right edge of the edge-type backlight unit, and
the lower light source unit of the edge-type backlight unit further comprises light sources disposed on a lower left edge and a lower right edge of the edge-type backlight unit.

7. The method of claim 1, wherein the controlling the turn-on and turn-off periods comprises synchronizing the turn-on and turn-off periods with a period in which a 3D image is output on the LCD panel by using a vertical synchronization signal.

8. The method of claim 1, further comprising outputting alternately a left image and a right image of the 3D image on the LCD panel.

9. The method of claim 8, further comprising outputting sequentially the left image, a black image, the right image, and the black image, during a period in which a pair of the left image and the right image corresponding to each other are alternately output.

10. The method of claim 8, further comprising outputting sequentially the left image, the left image, the right image, and the right image, during a period in which a pair of the left image and the right image corresponding to each other are alternately output.

11. The method of claim 8, further comprising outputting the left image and the right image sequentially, from an upper portion to a lower portion of the LCD panel.

12. The method of claim 8, further comprising controlling the 3D image to be output on the LCD panel at a frequency of 240 Hz.

13. The method of claim 1, wherein
a period, during which one of a left image and a right image of the 3D image is output and a next image is output on the LCD panel, is divided into six sections, and the controlling comprises:
(a) turning on the upper light source unit in a second section and a third section of the period;
(b) turning off the upper light source unit in a first section, a fourth section, a fifth section, and a sixth section of the period;
(c) turning on the lower light source unit in the fourth section and the fifth section of the period;
(d) turning off the lower light source unit in the first section, the second section, the third section, and the sixth section of the period; and
repeating steps (a)-(d) for each period during which one of the left image and the right image and the next image of the 3D image are output.

14. The method of claim 1, wherein
a period, during which one of a left image and a right image of the 3D image is output and a next image is output on the LCD panel, is divided into eight sections, and the controlling comprises:
(a) turning on the upper light source unit in a second section, a third section, a fourth section, and an fifth section of the period;
(b) turning off the upper light source unit in a first section, a sixth section, a seventh section, and an eighth section of the period;
(c) turning on the lower light source unit in the fourth section, the fifth section, the sixth section, and the seventh section of the period;
(d) turning off the lower light source unit in the first section, the second section, the third section, and the eighth section of the period; and
repeating steps (a)-(d) for each period during which one of the left image and the right image and the next image of the 3D image are output.

15. The method of claim 1, wherein when the LCD panel further comprises a shutter glass for a left image of the 3D image and a shutter glass for a right image of the 3D image, the method further comprises, during a period in which one of the left image and the right image of the 3D image is output and a next image is output on the LCD panel, controlling the shutter glasses such that the shutter glass for the left image is open while the left image is being output if the left image is first output, and the shutter glass for the right image is open while the right image is being output if the right image is first output.

16. A liquid crystal display (LCD) device comprising:
an LCD panel;
an edge-type backlight unit which comprises an upper light source unit comprising a light source disposed on an upper edge of the edge-type backlight unit, and a lower light source unit comprising a light source disposed on a lower edge of the edge-type backlight unit;
an LCD panel control unit which controls the LCD panel such that a left image and a right image of a three-dimensional (3D) image are alternately output on the LCD panel; and
a backlight control unit which controls the upper light source unit and the lower light unit so that turn-on and turn-off periods of the upper light source unit and the lower light source unit of the edge-type backlight unit are synchronized with a period during which the 3D image is output on the LCD panel.

17. The LCD device of claim 16, wherein
the upper light source unit of the edge-type backlight unit further comprises light sources disposed on an upper left edge and an upper right edge of the edge-type backlight unit, and
the lower light source unit of the edge-type backlight unit further comprises light sources disposed on a lower left edge and a lower right edge of the edge-type backlight unit.

18. The LCD device of claim 16, further comprising:
shutter glasses for the left image and the right image; and
a shutter glass control unit which controls opening and closing of the shutter glasses to be synchronized with a period during which the 3D image is output on the LCD panel.

19. The LCD device of claim 16, wherein the backlight control unit turns on the upper light source unit and turns off the lower light source unit when a current image is output on an upper portion of a screen and a previous image remains on a lower portion of the screen.

20. The LCD device of claim 16, wherein the backlight control unit turns off the upper light source unit and turns on the lower light source unit when a next image starts to be output on an upper portion of the screen and a current image is output on a lower portion of the screen.

21. The LCD device of claim 16, wherein the backlight control unit turns off the upper light source unit and the lower light source unit if a ratio of a current image to a previous image that mixedly exist on an entire screen is greater than or equal to a threshold.

22. The LCD device of claim 16, wherein the backlight control unit turns on the upper light source unit and the lower light source unit if a ratio of a current image and a previous image that mixedly exist over an entire screen is smaller than a threshold.

23. A non-transitory computer-readable recording medium having embodied thereon a program for executing the method of controlling the LCD device of claim 1.

24. A method comprising:
outputting images comprising sequential pairs of left images and right images corresponding to each other, from an upper portion to a lower portion of a screen;
turning on an upper light source unit disposed proximate an upper edge of an edge-type backlight unit and turning off a lower light source unit when a current image is output on the upper portion of the screen and a previous image remains on the lower portion of the screen; and
turning off the upper light source unit and turning on the lower light source unit disposed on a lower edge of the edge-type backlight unit when a next image is output on the upper portion of the screen and the current image is output on the lower portion of the screen, so that a cross-talk between adjacent left and right images is prevented.

25. The method of claim 24, further comprising:
determining a ratio of the current image and the previous image currently present on the screen; and
one of turning off the upper light source unit and the lower light source unit if the ratio is greater than or equal to a threshold, and turning on the upper light source unit and the lower light source unit if the ratio is smaller than the threshold.

26. The method of claim 24, wherein the upper light source unit comprises a plurality of light sources disposed proximate the upper edge of the edge-type backlight unit and the lower light source unit comprises a plurality of light sources disposed proximate the lower edge of the edge-type backlight unit.
